(19) United States
(12) Patent Application Publication
(10) Pub. No.: US 2025/0137413 A1
(43) Pub. Date: May 1, 2025

(54) APPARATUS AND METHOD FOR CONTROLLING INTAKE AIR TEMPERATURE

(71) Applicant: GM GLOBAL TECHNOLOGY OPERATIONS LLC, Detroit, MI (US)

(72) Inventors: Chengke Liu, Novi, MI (US); Rafat F. Hattar, Royal Oak, MI (US); John Michael Ellenberger, Huntington Woods, MI (US); Vijay A. Ramappan, Novi, MI (US); Andrew B. Gillett, Bloomfield Twp, MI (US)

(73) Assignee: GM GLOBAL TECHNOLOGY OPERATIONS LLC, Detroit, MI (US)

(21) Appl. No.: 18/500,018

(22) Filed: Nov. 1, 2023

(51) Int. Cl. F02D 41/00

(52) U.S. Cl. CPC F02D 41/0052; F02D 41/0002; F02D 41/0077; F02D 2200/0414; F02D 2200/70

(57) ABSTRACT

Methods for operating internal combustion engines and methods for controlling intake air temperature in engines of vehicles are provided. An engine includes an intake system configured to deliver intake air to the internal combustion engine; an exhaust system configured to discharge exhaust gas from the internal combustion engine; and an exhaust gas recirculation (“EGR”) system configured to selectively deliver a portion of the exhaust gas to the intake system. The internal combustion engine is located in an underhood zone; the intake system includes a first intake pipe having an outlet in communication with the intake system and having an inlet located outside of the underhood zone to receive ambient air; and the intake system includes a second intake pipe having an outlet in communication with the intake system and having an inlet located within the underhood zone to receive air warmed by the internal combustion engine.

### INTRODUCTION

The technical field generally relates to internal combustion engine arrangements, and more particularly to arrangements for controlling the temperature of intake air.

Contemporary internal combustion engines, including both diesel and gasoline engines, often utilize exhaust gas recirculation (“EGR”) for both fuel consumption improvements and for the reduction of regulated tailpipe exhaust gas emissions. EGR systems typically include an EGR valve that is located after the combustion chamber (engine cylinders) in the exhaust system, and can open to different levels, as controlled by the engine control unit (ECU). Thus, the EGR valve may precisely regulate the amount of exhaust gas that is recirculated as a diverted stream and mixed with fresh intake air.

The EGR valve allows harmful gas to re-enter the intake system, changing the chemical composition of the returning air, which causes the fuel mixture to burn slower, lowering the temperature in the combustion chamber and reducing nitrogen oxides (NOx) and carbon dioxide production for improved efficiency and air quality.

The post-combustion exhaust gas includes water vapor. When the EGR valve is partially open, and fresh air being introduced to the intake system is sufficiently cold, the water vapor may condense and freeze at the intake system.

Accordingly, it is desirable to provide an apparatus and method for controlling the temperature of the intake air, such as to avoid freezing of water from the recycled exhaust gas stream. Additionally, other desirable features and characteristics of the present disclosure will become apparent from the subsequent description taken in conjunction with the accompanying drawings and the foregoing introduction.

### SUMMARY

In one embodiment, an internal combustion engine includes an intake system configured to deliver intake air to the internal combustion engine: an exhaust system configured to discharge exhaust gas from the internal combustion engine; and an exhaust gas recirculation (“EGR”) system configured to selectively deliver a portion of the exhaust gas to the intake system. The internal combustion engine is located in an underhood zone: the intake system includes a first intake pipe having an outlet in communication with the intake system and having an inlet located outside of the underhood zone to receive ambient air; and the intake system includes a second intake pipe having an outlet in communication with the intake system and having an inlet located within the underhood zone to receive air warmed by the internal combustion engine.

In an exemplary embodiment, the internal combustion engine further includes a first valve configured to limit flow of ambient air to the intake system; and a second valve configured to limit flow of air warmed by the internal combustion engine to the intake system.

In an exemplary embodiment, the internal combustion engine further includes a first valve configured to limit flow of ambient air to the intake system: a second valve configured to limit flow of air warmed by the internal combustion engine to the intake system; and a control module configured to selectively open and close the first valve and the second valve to obtain a desired first rate of flow of the ambient air and a desired second rate of flow of the air warmed by the internal combustion engine.

In an exemplary embodiment, the internal combustion engine further includes a first valve configured to limit flow of ambient air to the intake system: a second valve configured to limit flow of air warmed by the internal combustion engine to the intake system: a sensor for obtaining data related to operation of the internal combustion engine; and a control module configured to determine a desired first rate of flow of the ambient air and a desired second rate of flow of the air warmed by the internal combustion engine to the intake system based on the data, and configured to selectively open and close the first valve and the second valve to obtain the desired first rate of flow of the ambient air and the desired second rate of flow of the air warmed by the internal combustion engine.

In an exemplary embodiment, the internal combustion engine further includes an EGR valve configured to limit flow of the portion of the exhaust gas to the intake system: a first valve configured to limit flow of ambient air to the intake system: a second valve configured to limit flow of air warmed by the internal combustion engine to the intake system: a sensor for obtaining data related to operation of the internal combustion engine; and a control module configured to determine a desired EGR operation mode based on the data: determine a desired first rate of flow of the ambient air and a desired second rate of flow of the air warmed by the internal combustion engine to the intake system based on the data: selectively open and close the first valve and the second valve to obtain the desired first rate of flow of the ambient air and the desired second rate of flow of the air warmed by the internal combustion engine; and selectively open and close the EGR valve to operate the internal combustion engine in the desired EGR operation mode.

In an exemplary embodiment, the internal combustion engine further includes an exhaust heat transfer enclosure, wherein: a portion of the exhaust system is located in the exhaust heat transfer enclosure: the inlet of the second intake pipe located within the underhood zone to receive air warmed by the internal combustion engine is a first inlet: the first inlet is in communication with the exhaust heat transfer enclosure; and the second intake pipe includes a second inlet located outside of the underhood zone to receive ambient air.

In an exemplary embodiment of the internal combustion engine, the exhaust system includes an exhaust manifold; and the exhaust heat transfer enclosure is contoured to the exhaust manifold.

In an exemplary embodiment, the internal combustion engine further includes a first valve configured to limit flow of ambient air through the first intake pipe to the intake system; a second valve configured to limit flow of air warmed by the internal combustion engine to the intake system; and a third valve configured to limit flow of ambient air through the second intake pipe to the exhaust heat transfer enclosure.

In an exemplary embodiment, the internal combustion engine further includes an EGR valve configured to limit flow of the portion of the exhaust gas to the intake system: a sensor for obtaining data related to operation of the internal combustion engine; and a control module configured to: determine a desired EGR operation mode based on the data: determine a desired first rate of flow of the ambient air through the first intake pipe to the intake system, determine a desired second rate of flow of the air warmed by the internal combustion engine to the intake system, and determine a desired third rate of flow of the ambient air through the second intake pipe to the exhaust heat transfer enclosure based on the data: selectively open and close the first valve, the second valve, and the third valve to obtain the desired first rate of flow, the desired second rate of flow, and the desired third rate of flow; and selectively open and close the EGR valve to operate the internal combustion engine in the desired EGR operation mode.

In another embodiment, a method for operating an internal combustion engine includes delivering intake air to the internal combustion engine with an intake system, wherein: the intake system and the internal combustion engine are located in an underhood zone: a first mode of operation flows ambient air from outside the underhood zone to form the intake air; and a second mode of operation flows heated air warmed by the internal combustion engine to form at least a portion of the intake air: discharging exhaust gas from the internal combustion engine to an exhaust system; and selectively delivering a portion of the exhaust gas to the intake system as a portion of the intake air.

In an exemplary embodiment, the method further includes obtaining data related to operation of the internal combustion engine; and determining whether to operate the internal combustion engine in the first mode of operation or the second mode of operation based on the data.

In an exemplary embodiment, the method further includes obtaining data related to operation of the internal combustion engine: determining whether exhaust gas recirculation (“EGR”) is desired based on the data; and delivering the portion of the exhaust gas to the intake system as a portion of the intake air when EGR is desired.

In an exemplary embodiment of the method, the internal combustion engine includes an exhaust heat transfer enclosure: a portion of the exhaust system is located in the exhaust heat transfer enclosure; and the heated air warmed by the internal combustion engine is air from the exhaust heat transfer enclosure.

In an exemplary embodiment of the method, a sub-mode of the first mode of operation flows ambient air from outside the underhood zone to the exhaust heat transfer enclosure.

In another embodiment, a method for controlling an intake air temperature in an engine of a vehicle includes selectively recycling a portion of an exhaust gas from the engine to an intake system of the engine to reduce a temperature of the engine: determining that ambient air outside the vehicle is colder than a selected temperature; and in response to determining that the ambient air outside the vehicle is colder than the selected temperature, flowing heated air from an underhood zone of the vehicle to the intake system of the engine.

In an exemplary embodiment, the method further includes determining that the ambient air outside the vehicle is not colder than a selected temperature: in response to determining that the ambient air outside the vehicle is not colder than the selected temperature, reducing or ceasing flow of the heated air from the underhood zone of the vehicle to the intake system of the engine; and flowing ambient air from outside the vehicle to the intake system of the engine.

In an exemplary embodiment, the method further includes maintaining the intake air temperature within a desired temperature range by controlling a flow of heated air from the underhood zone of the vehicle to the intake system of the engine and controlling a flow of ambient air from outside the vehicle to the intake system of the engine.

In an exemplary embodiment of the method, the engine includes an exhaust manifold and an exhaust heat transfer enclosure: the exhaust heat transfer enclosure abuts the exhaust manifold; and flowing heated air from the underhood zone of the vehicle to the intake system of the engine includes flowing heated air from the exhaust heat transfer enclosure to the intake system of the engine.

In an exemplary embodiment of the method, the engine includes an exhaust heat transfer enclosure: flowing heated air from the underhood zone of the vehicle to the intake system of the engine includes flowing heated air from the exhaust heat transfer enclosure to the intake system of the engine; and the method further includes: determining that the ambient air outside the vehicle is not colder than a selected temperature; and in response to determining that the ambient air outside the vehicle is not colder than the selected temperature, ceasing flow of heated air from the exhaust heat transfer enclosure to the intake system of the engine and flowing ambient air from outside the vehicle to the exhaust heat transfer enclosure.

In an exemplary embodiment of the method, the vehicle includes a front shutter configured to regulate a flow of free ambient air into the underhood zone of the vehicle; and the method further includes selectively partially closing the front shutter to increase underhood air temperatures and selectively fully opening the front shutter to decrease underhood air temperatures.

### DESCRIPTION OF THE DRAWINGS

The present disclosure will hereinafter be described in conjunction with the following drawing figures, wherein like numerals denote like elements, and wherein:

FIG. 1 is a schematic view of a vehicle and internal combustion engine suitable for using exemplary embodiments of the present disclosure;

FIG. 2 is a schematic view of a vehicle and internal combustion engine suitable for using exemplary embodiments of the present disclosure:

FIG. 3 is a flow chart for use by a control module in executing a method for operating an internal combustion engine of FIG. 1 or FIG. 2, according to embodiments of the present disclosure; and

FIG. 4 is a perspective view of the engine and other components under the hood of the vehicle according to embodiments of the present disclosure.

### DETAILED DESCRIPTION

The following detailed description is merely exemplary in nature and is not intended to limit the application and uses of embodiments herein. Furthermore, there is no intention to be bound by any expressed or implied theory presented in the preceding introduction and brief summary or the following detailed description. As used herein, the term “module” refers to any hardware, software, firmware, electronic control unit or component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of automated driving systems including cruise control systems, automated driver assistance systems and autonomous driving systems, and that the vehicle system described herein is merely one example embodiment of the present disclosure.

For the sake of brevity, conventional techniques and components related to vehicle mechanical parts and other functional aspects of the system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention. It should also be understood that the figures are merely illustrative and may not be drawn to scale.

Additionally, the following description refers to elements or features being “connected” or “coupled” together. As used herein, “connected” may refer to one element/feature being directly joined to (or directly communicating with) another element/feature, and not necessarily mechanically. Likewise, “coupled” may refer to one element/feature being directly or indirectly joined to (or directly or indirectly communicating with) another element/feature, and not necessarily mechanically. However, it should be understood that, although two elements may be described below, in one embodiment, as being “connected,” in alternative embodiments similar elements may be “coupled,” and vice versa. Thus, although the schematic diagrams shown herein depict example arrangements of elements, additional intervening elements, devices, features, or components may be present in an actual embodiment.

The term “intake air” is used herein as is common in the industry to refer to any gas stream including a portion of air, which may be mixed with a portion of exhaust gas or other gases. For example, a mixture of ambient air and/or heated air from within the engine compartment with a portion of recirculated exhaust gas may be referred to as intake air, as is common.

An exemplary vehicle, internal combustion engine, and method are provided to avoid freezing water from an EGR diverted stream at an engine intake system. In exemplary embodiments, heated air from an underhood zone of the vehicle is mixed with fresh ambient air from outside the vehicle to increase the temperature of the intake air before being mixed with the EGR diverted stream. As a result, freezing at the intake air system is avoided.

Freezing of water in the EGR diverted stream only occurs at sufficiently low temperatures. Therefore, sensors and a control module are provided to monitor the ambient air temperature, i.e., the temperature of fresh air from outside of the vehicle, as well as the temperatures at various locations within the vehicle. The control module may control flow of ambient air from outside the vehicle to the intake system, flow of heated air from within the vehicle to the intake system, and flow of the diverted EGR stream of exhaust to the intake system.

Further, some embodiments may provide for flowing ambient air from outside the vehicle directly to the exhaust manifolds to provide cooling thereof.

In summary, embodiments herein realize intake air temperature control by mixing preheated air from under the vehicle hood with ambient air under low ambient temperature conditions. This approach avoids ice formation when flowing the diverted EGR stream at high speed and load conditions for the application with either diesel or gasoline engines with low pressure EGR. As a secondary benefit, when the ambient temperatures are high and the vehicle is operating at high speed and loads, air from outside the hood can be directly flowed to the exhaust manifold to reduce the exhaust and catalyst temperatures. Also, a control logic is developed to determine whether to activate EGR based on ambient temperatures, vehicle speeds, and loads. Controlling the intake air temperature for low and medium speeds/loads operations at the cold ambient conditions can achieve better fuel economy and emissions.

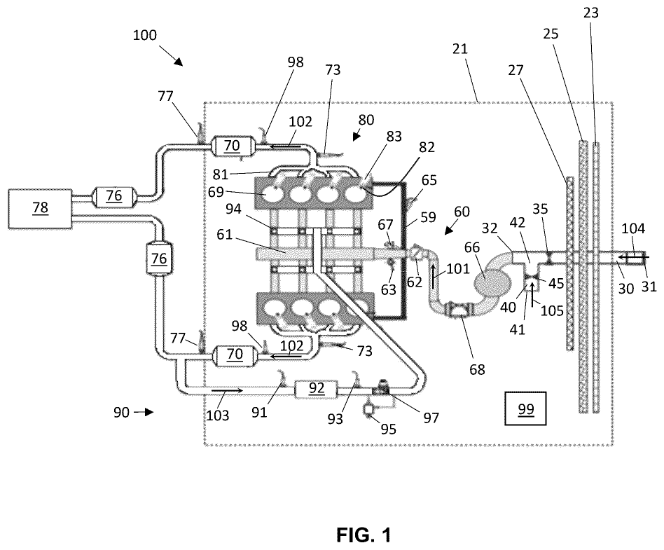

Referring to the drawings, wherein like reference numbers refer to like components, FIG. 1 is a simplified schematic representation of an embodiment of an internal combustion engine 100 for a vehicle suitable for use with exemplary embodiments of the present disclosure. The vehicle 110 may be any vehicle having an internal combustion engine 100. The vehicle 110 may be any one of a number of different types of vehicles, such as, for example, a sedan, a wagon, a truck, or a sport utility vehicle (SUV), and may be two-wheel drive (2WD), four-wheel drive (4WD), or all-wheel drive (AWD). In various embodiments, the vehicle 110 may incorporate any one of, or combination of, a number of different types of engines, such as, for example, a gasoline or diesel fueled combustion engine, a flex fuel vehicle (FFV) engine (i.e., using a mixture of gasoline and alcohol).

In FIG. 1, the exemplary internal combustion engine, generally indicated as 100, is shown equipped for efficient operation under various conditions. As shown, an intake system 60 is provided for delivering intake air 101 to the internal combustion engine 100. Further, an exhaust system is provided to discharge exhaust gas 102 from the internal combustion engine 100. Also, an exhaust gas recirculation (“EGR”) system 90 is provided to selectively deliver a portion 103 of the discharge exhaust gas 102 to the intake system 60. Typically, the discharge exhaust gas 102 is lower in oxygen than the intake air 101. With less oxygen received, the diluted fuel mixture may burn more slowly, lowering temperatures in the engine combustion chamber and reducing production of nitrogen oxides.

As shown, the internal combustion engine 100 is located in an underhood zone 21, i.e., under the hood of a vehicle 110 being powered by the engine 100. As shown, the intake system 60 may also be located in the underhood zone 21. Further, a portion of the exhaust system 80 may be located in the underhood zone 21.

The intake system 60 may include an air filter 66 and an air flow meter 68 downstream of the air filter 66. Further, the intake system 60 may include an intake throttle 62 for receiving the intake air 101 from the air flow meter 68. The intake system 60 includes an intake manifold 61 located downstream of the intake throttle 62.

The internal combustion engine 100 includes a plurality of cylinders 69 into which air flows from the intake manifold 61. Specifically, the manifold 61 receives a compressed intake charge of intake air 101 from the intake system 60 through the intake throttle 62 and delivers the charge to the plurality of cylinders 69.

The cylinders 69 receive a combination of a charge of the intake air 101 and fuel delivered by the fuel rail 59. The intake air/fuel mixture is combusted in the cylinders 69 with a spark from spark plugs 82, resulting in reciprocation of pistons (not shown) therein. The spark plugs 82 may be operated by a high voltage cable 83. The reciprocation of the pistons rotates a crankshaft (not shown) to deliver motive power to a vehicle powertrain (not shown) or to a generator or other stationary recipient of such power (not shown) in the case of a stationary application of the internal combustion engine 100.

The exhaust system 80 includes an exhaust manifold 81. In FIG. 1, the exhaust manifold 81 is a split manifold 81 providing two flow paths for the exhaust gas 102 away from the engine 100.

The exhaust manifold 81 is in fluid communication with the cylinders 69 and is configured to remove the combusted constituents of the intake charge/fuel mixture (i.e., exhaust gas 102). The exhaust manifold 81 delivers the exhaust gas 102 to various exhaust after treatment devices that are configured to treat various regulated constituents of the exhaust gas 102 prior to its release to the atmosphere.

For example, the exhaust system 80 may include closed coupled catalytic converters 70 and underfloor catalytic converters 76 that receive the exhaust gas 102 from the exhaust manifold 81. Further, the exhaust system 80 may include a muffler 78 through which the exhaust gas 102 passes before being released.

As shown, the exhaust system 80 is provided with a variety of sensors. For example, the exhaust system 80 may include front oxygen sensors 73 at the front of the closed coupled catalytic converters 70 and rear oxygen sensors 77 behind the closed coupled catalytic converters 70.

Likewise, the intake system 60 is provided with a variety of sensors. For example, an intake manifold pressure sensor 63 is provided at the intake manifold 61. Further, a temperature sensor 67 is provided downstream of the intake throttle 62. Also, a pressure sensor 65 is provided at the fuel rail 59.

As shown, the internal combustion engine 100 further includes the exhaust gas recirculation (“EGR”) system 90. The EGR system 90 is provided to selectively remove a portion 103 of the discharge exhaust gas 102 and recirculate the diverted portion 103 to the intake system 60. As shown, the EGR system 90 includes an EGR cooler 92 for cooling the diverted portion 103. Also, the EGR system 90 include an EGR valve 97 for selectively opening and closing to activate and deactivate flow of the diverted portion 103, and to meter the flow of the diverted portion 103 to a desired flow rate. Further, the EGR system 90 includes EGR diffusers 94 that define passages for the even distribution of the diverted portion 103 into the intake charge of intake air 101 at the intake manifold 61.

The EGR system 90 further includes a variety of sensors. For example, an upstream temperature sensor 91 is provided upstream of the EGR cooler 92 and a downstream temperature sensor 93 is provided downstream of the EGR cooler 92. Further, a differential pressure sensor 95 is provided at the EGR valve 97 to determine the differential pressure across the EGR valve 97. Also, the EGR system 90 may include analog temperature sensors 98 located upstream of the closed coupled catalytic converters 70 of the exhaust system 80.

Further, the intake system 60 includes a first pipe 30 for receiving ambient air 104 from outside the underhood zone 21. As shown, the first pipe 30 includes a first end 31, which may be an inlet, located outside of the underhood zone 21. Further, the first pipe 30 extends into the underhood zone 21 to a second end 32, which may be an outlet, connected to other piping of the intake system 60, i.e., second end 32 is in communication with the intake system 60. As shown, an air flow control valve 35 is located in the first pipe 30 for controlling flow of ambient air 104 to the intake system 60. In certain embodiments, the first end 31 is the only component or feature of the intake system 60 that is located outside the underhood zone 21.

Also, the intake system 60 includes a second pipe 40 for receiving heated air 105 from within the underhood zone 21, i.e., air heated by the engine 100. As shown, the second pipe 40 includes a first end 41, which may be an inlet, located within the underhood zone 21. Further, the second pipe 40 extends to a second end 42, which may be an outlet, connected to other piping of the intake system 60, i.e., second end 42 is in communication with the intake system 60. In certain embodiments, the second pipe 40 may connect to the first pipe 30 downstream of the air flow control valve 35, though other arrangements are contemplated. As shown, an air flow control valve 45 is located in the second pipe 40 for controlling flow of heated air 105 to the intake system 60.

As further shown in FIG. 1, the engine 100 may be provided with an optional front shutter 23. The front shutter 23 may be closed to stop or reduce flow of ambient air into the underhood zone 21 from outside the underhood zone 21, i.e., ambient air that is free flowing, not air flowing within first pipe 30. When the front shutter 23 is open, ambient air may enter the underhood zone 21 from outside the underhood zone 21. The engine 100 is further provided with a radiator 25 and with an engine cooling fan 27. The front shutter 23, radiator 25, and engine cooling fan 27 are located in the underhood zone 21.

As further shown, the engine 100 is provided with a controller or control module 99 configured to selectively open and close the valve 35 and the valve 45 to obtain a desired first rate of flow of the ambient air 104 and a desired second rate of flow of the heated air 105. The control module 99 may include, may be part of, or may be an engine control module (ECM) or engine control unit (ECU). The control module 99, may include any type of processing element or vehicle controller, and may be equipped with nonvolatile memory, random access memory (RAM), discrete and analog input/output (I/O), a central processing unit, and/or communications interfaces for networking within a vehicular communications network. The control module 99 may be further configured to operate the EGR valve 97 to adjust the volumetric quantity of diverted exhaust gas 103 that is introduced to the intake system 60, based on the particular engine operating conditions at any given time.

The control module 99 collects information regarding the operation of the internal combustion engine 100 from the sensors in the intake system 60, exhaust system 80, and EGR system 90, such as the temperature of the exhaust system, engine coolant, compressed combustion charge, ambient, etc., as well as pressure, exhaust system conditions and driver demand to determine the appropriate, if any, flow of diverted exhaust gas 103 to be recirculated to the intake system 60, to determine the appropriate, if any, flow of ambient air 104 to the intake system 60, and to determine the appropriate, if any, flow of heated underhood air 105 to the intake system 60.

The control module 99 may be in communication other sensors located in the vehicle 110 outside of the illustrated intake system 60, exhaust system 80, and EGR system 90. For example, the control module 99 may receive wheel speed information from a wheel speed sensor.

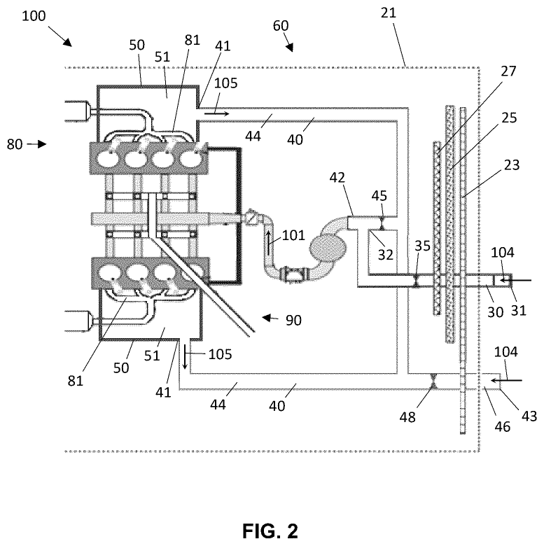

FIG. 2 illustrates another embodiment of an internal combustion engine 100 provided with an intake system 60 for delivering intake air 101 having desired characteristics for use with an EGR system 90. The engine 100 shares many of the same features as the engine 100 of FIG. 1 and description thereof is not repeated. Further, portions of the exhaust system 80 and the EGR system 90 are not illustrated for purposes of clarity.

In FIG. 2, the exhaust system 80 is provided with heat transfer enclosures 50, that are illustrated as surrounding or enclosing the exhaust manifolds 81. The heat transfer enclosures 50 define exhaust manifold internal subzones 51 that are at least partially isolated from the rest of the underhood zone 21.

As shown in FIG. 2, the intake system 60 includes a first pipe 30 for receiving ambient air 104 from outside the underhood zone 21. As shown, the first pipe 30 includes a first end 31, which may be an inlet, located outside of the underhood zone 21. Further, the first pipe 30 extends into the underhood zone 21 to a second end 32, such as an outlet, connected to other piping of the intake system 60, i.e., second end 32 is in communication with the intake system 60. As shown, an air flow control valve 35 is located in the first pipe 30 for controlling flow of ambient air 104 to the intake system 60.

In FIG. 2, the second pipe 40 has a different structure as compared to the embodiment of FIG. 1. In the embodiment of FIG. 2, the second pipe 40 is forked and includes first legs 44 extending to the heat transfer enclosures 50 and a second leg 46 extending to outside the underhood zone 21.

In FIG. 2, first ends 41 of the second pipe 40 terminate the first legs 44 and are located at the heat transfer enclosures 50 surrounding the exhaust manifolds 81. Thus, the first ends 41 of the second pipe 40 are in fluid communication with the exhaust manifold internal subzones 51. During certain modes of operation, the first ends 41 of the second pipe 40 may be inlets. As configured, the first ends 41 of the second pipe 40 may receive heated air 105 from within the exhaust manifold internal subzones 51, i.e., air heated by the engine 100 and specifically heated by the exhaust manifolds 81.

As shown, the second pipe 40 extends to a second end 42, which may be an outlet, connected to other piping of the intake system 60, i.e., second end 42 is in communication with the intake system 60. In certain embodiments, the second pipe 40 may connect to the first pipe 30 downstream of the air flow control valve 35, though other arrangements are contemplated. As shown, an air flow control valve 45 is located in the second pipe 40 for controlling flow to the intake system 60.

As shown, the second leg 46 of the second pipe 40 extends to a third end 43 located outside of the underhood zone 21. The third end 43 of the second pipe 40 may be an inlet for receiving ambient air 104 from outside the underhood zone 21. As shown, an air flow control valve 48 is located in the second leg 46 of the second pipe 40 for controlling flow of ambient air 104 through the second leg 46.

During certain modes of operation, the first ends 41 of the second pipe 40 are inlets for receiving heated air 105 from the exhaust manifold internal subzones 51 within the heat transfer enclosures 50. During other modes of operation, the first ends 41 of the second pipe 40 are outlets for delivering ambient air 104 from the third end to the exhaust manifold internal subzones 51 within the heat transfer enclosures 50. Accordingly, the valves 35, 45, and 48 may be controlled to provide desired flows to the intake system 60, and to or from the heat transfer enclosures 50.

For example, flow of ambient air 104 through the first pipe 30 to the intake system 60 is controlled by valve 35: flow of ambient air 104 through the second leg 46 may be directed to the first ends 41 by opening valve 48, and closing valve 45; and flow of heated air 105 through the second leg 46 may be directed to the intake system 60 by closing valve 48, and opening valve 45. Specific characteristics of the intake air 101 may be obtained by controlling flow rates through the various valves.

In an exemplary embodiment, the embodiments of FIGS. 1 and 2 are used in a method for operating an internal combustion engine 100. The method includes delivering intake air 101 to the internal combustion engine 100 with intake system 60. As described, the intake system 60 and the internal combustion engine 100 are located in an underhood zone 21 of the vehicle 110. In a first mode of operation, ambient air 104 flows from outside the underhood zone 21 to form the intake air 101. Specifically, the first pipe 30 delivers ambient air 104 to the intake system 60. In the first mode of operation, no heated air 105 is delivered to the intake system 60, i.e., valve 45 is closed.

In a second mode of operation, the second pipe 40 may deliver heated air 105 from the underhood zone 21, including from the exhaust manifold internal subzones 51 (as in FIG. 2) or from outside the exhaust manifold internal subzones 51 (as in FIG. 1). Specifically, the second pipe 40 delivers heated air 105 to the intake system 60. Thus, valve 45 is open. In the embodiment of FIG. 2, valve 48 may be closed. In the second mode of operation, ambient air 104 may be delivered to the intake system 60, i.e., valve 35 is open or no ambient air 104 may be delivered to the intake system 60, i.e., valve 35 is closed. More specifically, the flow rates of ambient air 104 and heated air 105 may be controlled, i.e., closed or opened to a selected degree to obtain a desired intake air 101, such as intake air 101 at a desired temperature.

The method of operation further includes discharging exhaust gas 102 from the internal combustion engine 100 to the exhaust system 80, and selectively delivering a portion 103 of the discharge exhaust gas 102 to the intake system 60 as a portion of the intake air 101.

In exemplary embodiments, the method includes obtaining data related to operation of the internal combustion engine 100, such as from the sensors described above. Further, in the method, the control module 99 determines whether to operate the internal combustion engine 100 in the first mode of operation or in the second mode of operation based on the data. Also, the control module 99 determines whether exhaust gas recirculation (“EGR”) is desired based on the data and the method includes delivering the portion 103 of the discharge exhaust gas 102 to the intake system 60 as a portion of the intake air 101 when EGR is desired.

For the embodiment of FIG. 2, the method includes, in a sub-mode of the first mode of operation, flowing ambient air 104 from outside the underhood zone 21 to the exhaust heat transfer enclosure 50.

In another embodiment, a method for controlling an intake air temperature in an engine 100 of a vehicle includes selectively recycling a portion 103 of an exhaust gas 102 from the engine 100 to the intake system 60 of the engine 100 to reduce a temperature of the engine 100. Further, the method includes determining that ambient air 104 outside the vehicle is colder than a selected temperature. In response to determining that the ambient air 104 outside the vehicle is colder than the selected temperature, the method includes flowing heated air 105 from the underhood zone 21 of the vehicle to the intake system 60 of the engine 100.

In exemplary embodiments, the method includes determining that the ambient air 104 outside the vehicle is not colder than a selected temperature, and, in response to determining that the ambient air outside the vehicle is not colder than the selected temperature, reducing or ceasing flow of heated air 105 from the underhood zone 21 to the intake system 60 and flowing ambient air 104 from outside the vehicle to the intake system 60.

In exemplary embodiments, the method includes maintaining the intake air temperature within a desired temperature range by controlling a flow of heated air 105 from the underhood zone 21 to the intake system 60 and controlling a flow of ambient air 104 from outside the vehicle to the intake system 60.

In the embodiment of FIG. 2, the method may include determining that the ambient air outside the vehicle is not colder than a selected temperature, and in response to determining that the ambient air outside the vehicle is not colder than the selected temperature, ceasing flow of heated air 105 from the exhaust heat transfer enclosure 50 to the intake system 60 and flowing ambient air 104 from outside the vehicle to the exhaust heat transfer enclosure 50.

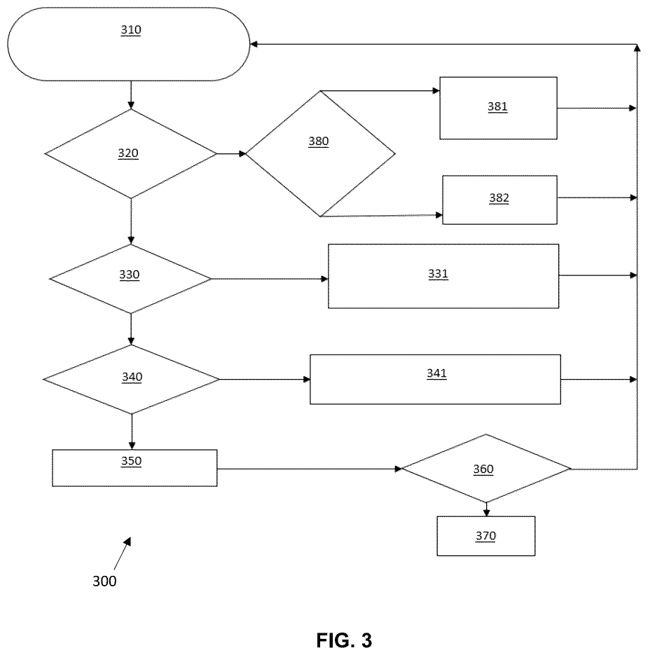

Referring now to FIG. 3, a flow chart is provided for performing a method 300 for operating an internal combustion engine 100. Method 300 provides an intake temperature control strategy at different ambient temperature conditions.

As shown, method 300 includes, at operation 310, obtaining engine control module (ECM) data, such as engine speed, torque, intake temperature, vehicle speed, etc.

At query 320, method 300 determines whether the ambient air temperature is less than a selected temperature. For example, the selected temperature may be zero degrees Celsius (0° C.). Other selected temperatures are contemplated, for example, the selected temperature may any temperature inside the range of −7° C. to 10° C.

If query 320 determines that the ambient air temperature is not less than the selected temperature, then method 300 continues at query 330, where method 300 determines whether the vehicle speed is greater than a selected speed and whether the engine load, i.e., the torque output of the engine, is greater than an upper selected load. For example, the selected speed may be sixty miles per hour (60 mph). Other selected vehicle speeds are contemplated, for example, the selected vehicle speed may be any speed inside the range of 30 mph to 80 mph. Further, the upper selected load may be an engine load of sixty percent (60%). Other upper selected loads are contemplated, for example, the selected load may be any load inside the range of 30% to 90%. As used herein, the engine load is measured as the percent of maximum power output of the engine at the given engine speed.

If query 330 determines that the vehicle speed is not greater than the selected speed or the engine load is not greater than the upper selected load, then method 300 continues at query 340, where method 300 determines whether the engine load is greater than a lower selected load. For example, the lower selected load may be an engine load of fifty percent (50%). Other lower selected loads are contemplated, for example, the selected load may be any load inside the range of 20% to 70%.

If query 340 determines that the engine load is greater than the lower selected load, then method 300 continues at operation 350 with normal engine operation, i.e., no heated air 105 is delivered to the intake system 60.

After operation 350, method 300 continues at query 360 with determining whether the engine speed is greater than zero (0 rpm).

If query 360 determines that the engine speed is not greater than zero (0 rpm), then method 300 continues at operation 370 with pausing operation of method 300. If query 360 determines that the engine speed is greater than zero (0 rpm), then method 300 returns to operation 310.

If query 320 determines that the ambient air temperature is less than the selected temperature, then method 300 continues at query 380, where method 300 determines whether the vehicle speed is greater than a selected vehicle speed, whether the engine load is greater than a lower selected load, and whether the ambient air temperature is greater than a lower selected temperature. In certain embodiments, the selected vehicle speed is sixty miles per hour (60 mph), the lower selected load is fifty percent (50%), and the lower selected ambient air temperature is negative seven degrees Celsius (−7° C.). Other selected vehicle speeds are contemplated, for example, the selected vehicle speed may be any speed inside the range of 30 mph to 80 mph. Other lower selected loads are contemplated, for example, the selected load may be any load inside the range of 20% to 70%. Other lower selected temperatures are contemplated, for example, the lower selected temperature may be any temperature inside the range of −15° C. to 5° C.

If query 380 determines that the vehicle speed is greater than a selected vehicle speed, that the engine load is greater than a lower selected load, and that the ambient air temperature is greater than a lower selected temperature, then method 300 continues at operation 381 with controlling the air flow control valves to direct heated air from the underhood zone to the intake system and to control the temperature of the intake air at a temperature of above zero degrees (0° C.). The conditions at operation 381 may be considered to be high vehicle speed/load and cold temperature. Operation 381 may use EGR to reduce exhaust temperature without engine enrichment to comply with PEMS regulations. After operation 381, method 300 returns to operation 310.

If query 380 determines that the vehicle speed is not greater than a selected vehicle speed, that the engine load is not greater than a lower selected load, or that the ambient air temperature is not greater than a lower selected temperature, then method 300 continues at operation 382 with using the normal intake system, i.e., without delivering heated air to the intake system, and with operating the engine without the EGR system, i.e., without delivering a portion of the exhaust gas to the intake system. After operation 382, method 300 returns to operation 310.

If query 330 determines that the vehicle speed is greater than the selected speed and that the engine load is greater than the upper selected load, then method 300 continues at operation 331 with controlling the air flow control valves to direct ambient air from the outside the vehicle directly to the exhaust manifold to reduce the exhaust gas temperature and catalyst aging. At operation 331, only ambient air (no heated air) is delivered to the intake system. At operation 331, the EGR system is not operated to deliver a portion of the exhaust gas to the intake system. After operation 331, method 300 returns to operation 310.

If query 340 determines that the engine load is not greater than the lower selected load, then method 300 continues at operation 341 with controlling the air flow control valves and the shutter to achieve optimized intake temperatures for low emission and better fuel economy. At operation 341, only ambient air (no heated air) is delivered to the intake system. At operation 341, the EGR system may be operated to deliver a portion of the exhaust gas to the intake system if needed. After operation 341, method 300 returns to operation 310.

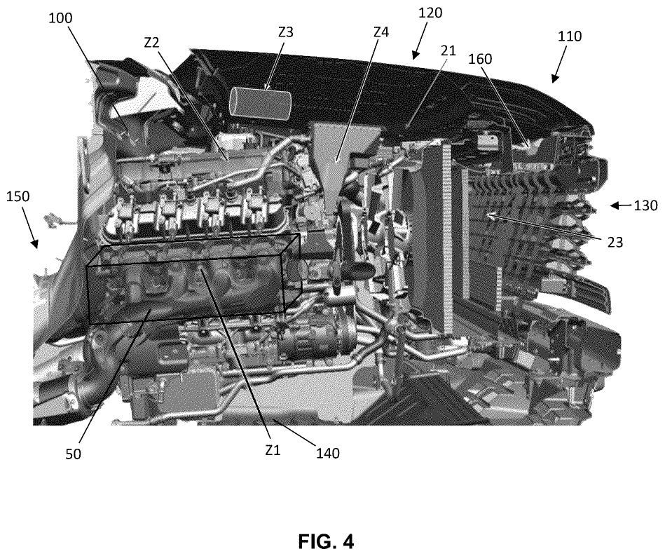

Referring now to FIG. 4, the location of the first end 41 of the second pipe 40 of the embodiment of FIG. 2 is further described. FIG. 4 illustrates a portion of the vehicle 110 in which the engine 100 is located. As shown, the vehicle 110 has a hood 120; a front 130, such as a grille: a chassis 140; and a passenger cabin 150. The underhood zone 21 referred to in FIGS. 1-2 is located between the hood 120 and the chassis 140, and between the front 130 and the cabin 150. An outside hood zone 160 is also identified.

Four additional underhood subzones Z1, Z2, Z3, and Z4 are identified in FIG. 4. Subzone Z1 is a located at an exhaust heat shield and connection pipe. Subzone Z2 is located in a top engine area, i.e., over the engine 100. Subzone Z3 is located in a top engine area close to the radiator. Subzone Z4 is located directly behind the radiator.

Cross-referencing FIGS. 2 and 4, it may be seen that the subzone Z1 includes the exhaust manifold internal subzone 51. Further, the heat transfer enclosure 50 may be formed with a shape that is contoured to the exhaust manifold 81 to optimize heat absorption from the exhaust gas for transfer to the heated air 105. Further, the heat transfer enclosure 50 has an additional function of enabling engine cooling when operating at a high load during high ambient air temperature conditions by directing ambient air 104 from the front 130 of the vehicle 110 to the heat transfer enclosure 50 as described above.

Cross-referencing FIGS. 1, 2, and 4, it may be seen that the first end 41 of the second pipe 40 may be located at any of the subzones Z1, Z2, Z3, Z4, including within exhaust manifold internal subzones 51.

In summary, embodiments herein control intake air temperature by selecting whether heated air from different underhood zones, including the exhaust manifold internal zone, is delivered to the intake system. Embodiments herein determine whether the EGR system is used to divert a portion of the exhaust gas is delivered to the intake system based on ambient temperatures, vehicle speeds, and loads. Embodiments herein control the intake manifold temperatures during low and medium speeds and load operations to achieve better fuel economy and emissions at cold ambient conditions by cooling the intake manifolds by delivering ambient air directly to the intake manifolds.

Embodiments herein allow engine operation to meet portable emissions measurement system (PEMS) emission requirements without vehicle speed derate (currently vehicle speed is derated to 65 mph when performing full load towing), while solving the ice forming issue when flowing the EGR at the ambient temperature from −7° C. to 0° C.

Embodiments herein further reduce exhaust temperatures when operating at normal or high ambient temperature conditions, which can improve catalyst reliability or potential platinum group metals (PGM) loadings reductions.

Embodiments herein improve −7° C. (20° F.) Federal Test Procedure (FTP) emission or fuel economy at low ambient air temperature conditions.

Embodiments herein provide for control of intake air temperatures at all ambient air temperatures, even below freezing where EGR is normally disabled due to icing concerns.

In embodiments herein, at ambient air temperatures from −7° C. to 0° C., or even lower air temperatures, heated air from the underhood zone or exhaust manifold zone can be used to avoid ice forming in the intake system when using EGR to delivery a portion of exhaust gas to the intake system.

In embodiments herein, at a low vehicle speed with an ambient air temperature range of from −7° C. to 0° C., or even lower, no EGR is needed to meet PEMS regulation requirements.

In embodiments herein, both EGR bypass and underhood heated air can be used to improve intake manifold air temperatures at the cold ambient conditions.

In embodiments herein, at ambient air temperatures from −7° C. to 0° C., or even lower air temperatures, heated air from two exhaust manifold heat transfer enclosures can be delivered to the intake system to avoid ice forming in the intake system when flowing EGR.

In embodiments herein, when ambient air temperatures are hot, ambient air from the outside vehicle hood can be directly flowed to the exhaust manifold to reduce the exhaust temperature at higher vehicle speeds and loads conditions.

In embodiments herein, the intake air temperature can be controlled by balancing the air flow rates from both the outside the vehicle and the underhood or exhaust manifold heat transfer enclosure zones to achieve better PEMs and cycle emission performance at low ambient air temperature operations.

In embodiments herein, the heated air may be received from a selected zone within the underhood zone.

In embodiments herein, the heat transfer enclosure shape is contoured to the exhaust manifold shape to optimize heat absorption to the heated air.

In embodiments herein, the heat transfer enclosures have an additional function to enable engine cooling when operating at high load at the high ambient temperature conditions.

Embodiments herein control the intake manifold temperatures for low and medium speed and load operations to achieve better fuel economy and emissions under low temperature ambient conditions.

Embodiments herein partially close the front shutter at low speed and load operation with low ambient temperature to increase underhood air temperatures.

Embodiments herein fully open the front shutter during high load operations.

Embodiments herein reduce the EGR coolant flow in the EGR cooler to increase the EGR exhaust gas temperature entering the intake system in order to achieve an intake air temperature of greater than 0° C.

Embodiments herein use a higher fraction of the EGR exhaust gas in the intake air when operating with an ambient air temperature of −7° C. to achieve an intake air temperature of greater than 0° C.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing summary and detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An internal combustion engine comprising:
an intake system configured to deliver intake air to the internal combustion engine;
an exhaust system configured to discharge exhaust gas from the internal combustion engine; and
an exhaust gas recirculation (“EGR”) system configured to selectively deliver a portion of the exhaust gas to the intake system;
wherein the internal combustion engine is located in an underhood zone;
wherein the intake system includes a first intake pipe having an outlet in communication with the intake system and having an inlet located outside of the underhood zone to receive ambient air; and
wherein the intake system includes a second intake pipe having an outlet in communication with the intake system and having an inlet located within the underhood zone to receive air warmed by the internal combustion engine.

2. The internal combustion engine of claim 1, further comprising:
a first valve configured to limit flow of ambient air to the intake system; and
a second valve configured to limit flow of air warmed by the internal combustion engine to the intake system.

3. The internal combustion engine of claim 1, further comprising:
a first valve configured to limit flow of ambient air to the intake system;
a second valve configured to limit flow of air warmed by the internal combustion engine to the intake system; and
a control module configured to selectively open and close the first valve and the second valve to obtain a desired first rate of flow of the ambient air and a desired second rate of flow of the air warmed by the internal combustion engine.

4. The internal combustion engine of claim 1, further comprising:
a first valve configured to limit flow of ambient air to the intake system;
a second valve configured to limit flow of air warmed by the internal combustion engine to the intake system;
a sensor for obtaining data related to operation of the internal combustion engine; and
a control module configured to determine a desired first rate of flow of the ambient air and a desired second rate of flow of the air warmed by the internal combustion engine to the intake system based on the data, and configured to selectively open and close the first valve and the second valve to obtain the desired first rate of flow of the ambient air and the desired second rate of flow of the air warmed by the internal combustion engine.

5. The internal combustion engine of claim 1, further comprising:
an EGR valve configured to limit flow of the portion of the exhaust gas to the intake system;
a first valve configured to limit flow of ambient air to the intake system;
a second valve configured to limit flow of air warmed by the internal combustion engine to the intake system;
a sensor for obtaining data related to operation of the internal combustion engine; and
a control module configured to:
determine a desired EGR operation mode based on the data;
determine a desired first rate of flow of the ambient air and a desired second rate of flow of the air warmed by the internal combustion engine to the intake system based on the data;
selectively open and close the first valve and the second valve to obtain the desired first rate of flow of the ambient air and the desired second rate of flow of the air warmed by the internal combustion engine; and
selectively open and close the EGR valve to operate the internal combustion engine in the desired EGR operation mode.

6. The internal combustion engine of claim 1, further comprising an exhaust heat transfer enclosure, wherein:
a portion of the exhaust system is located in the exhaust heat transfer enclosure;
the inlet of the second intake pipe located within the underhood zone to receive air warmed by the internal combustion engine is a first inlet;
the first inlet is in communication with the exhaust heat transfer enclosure; and
the second intake pipe includes a second inlet located outside of the underhood zone to receive ambient air.

7. The internal combustion engine of claim 6, wherein:
the exhaust system comprises an exhaust manifold; and
the exhaust heat transfer enclosure is contoured to the exhaust manifold.

8. The internal combustion engine of claim 6, further comprising:
a first valve configured to limit flow of ambient air through the first intake pipe to the intake system;
a second valve configured to limit flow of air warmed by the internal combustion engine to the intake system; and
a third valve configured to limit flow of ambient air through the second intake pipe to the exhaust heat transfer enclosure.

9. The internal combustion engine of claim 8, further comprising:
an EGR valve configured to limit flow of the portion of the exhaust gas to the intake system;
a sensor for obtaining data related to operation of the internal combustion engine; and
a control module configured to:
determine a desired EGR operation mode based on the data;
determine a desired first rate of flow of the ambient air through the first intake pipe to the intake system, determine a desired second rate of flow of the air warmed by the internal combustion engine to the intake system, and determine a desired third rate of flow of the ambient air through the second intake pipe to the exhaust heat transfer enclosure based on the data;
selectively open and close the first valve, the second valve, and the third valve to obtain the desired first rate of flow, the desired second rate of flow, and the desired third rate of flow; and
selectively open and close the EGR valve to operate the internal combustion engine in the desired EGR operation mode.

10. A method for operating an internal combustion engine, the method comprising:
delivering intake air to the internal combustion engine with an intake system, wherein:
the intake system and the internal combustion engine are located in an underhood zone;
a first mode of operation flows ambient air from outside the underhood zone to form the intake air; and
a second mode of operation flows heated air warmed by the internal combustion engine to form at least a portion of the intake air:
discharging exhaust gas from the internal combustion engine to an exhaust system; and
selectively delivering a portion of the exhaust gas to the intake system as a portion of the intake air.

11. The method of claim 10, further comprising:
obtaining data related to operation of the internal combustion engine; and
determining whether to operate the internal combustion engine in the first mode of operation or the second mode of operation based on the data.

12. The method of claim 10, further comprising:
obtaining data related to operation of the internal combustion engine;
determining whether exhaust gas recirculation (“EGR”) is desired based on the data; and
delivering the portion of the exhaust gas to the intake system as a portion of the intake air when EGR is desired.

13. The method of claim 10, wherein:
the internal combustion engine comprises an exhaust heat transfer enclosure;
a portion of the exhaust system is located in the exhaust heat transfer enclosure; and
the heated air warmed by the internal combustion engine is air from the exhaust heat transfer enclosure.

14. The method of claim 13, wherein a sub-mode of the first mode of operation flows ambient air from outside the underhood zone to the exhaust heat transfer enclosure.

15. A method for controlling an intake air temperature in an engine of a vehicle, the method comprising:
selectively recycling a portion of an exhaust gas from the engine to an intake system of the engine to reduce a temperature of the engine;
determining that ambient air outside the vehicle is colder than a selected temperature; and
in response to determining that the ambient air outside the vehicle is colder than the selected temperature, flowing heated air from an underhood zone of the vehicle to the intake system of the engine.

16. The method of claim 15, further comprising:
determining that the ambient air outside the vehicle is not colder than a selected temperature;
in response to determining that the ambient air outside the vehicle is not colder than the selected temperature, reducing or ceasing flow of the heated air from the underhood zone of the vehicle to the intake system of the engine; and
flowing ambient air from outside the vehicle to the intake system of the engine.

17. The method of claim 15, further comprising:
maintaining the intake air temperature within a desired temperature range by controlling a flow of heated air from the underhood zone of the vehicle to the intake system of the engine and controlling a flow of ambient air from outside the vehicle to the intake system of the engine.

18. The method of claim 15, wherein:
the engine comprises an exhaust manifold and an exhaust heat transfer enclosure;
the exhaust heat transfer enclosure abuts the exhaust manifold; and
flowing heated air from the underhood zone of the vehicle to the intake system of the engine comprises flowing heated air from the exhaust heat transfer enclosure to the intake system of the engine.

19. The method of claim 15, wherein:
the engine comprises an exhaust heat transfer enclosure;
flowing heated air from the underhood zone of the vehicle to the intake system of the engine comprises flowing heated air from the exhaust heat transfer enclosure to the intake system of the engine; and
the method further comprises:
determining that the ambient air outside the vehicle is not colder than a selected temperature; and
in response to determining that the ambient air outside the vehicle is not colder than the selected temperature, ceasing flow of heated air from the exhaust heat transfer enclosure to the intake system of the engine and flowing ambient air from outside the vehicle to the exhaust heat transfer enclosure.

20. The method of claim 15, wherein:
the vehicle includes a front shutter configured to regulate a flow of free ambient air into the underhood zone of the vehicle; and
the method further comprises selectively partially closing the front shutter to increase underhood air temperatures and selectively fully opening the front shutter to decrease underhood air temperatures.
